(19) United States
(12) Patent Application Publication
(10) Pub. No.: US 2022/0364613 A1
(43) Pub. Date: Nov. 17, 2022

(54) A DRUM BRAKE SHOE AND AN APPARATUS AND METHOD FOR CHANGING SAME

(71) Applicant: Ken PITT, Hartley (AU)

(72) Inventor: Ken PITT, Hartley (AU)

(21) Appl. No.: 17/763,029

(22) PCT Filed: Sep. 23, 2020
(86) PCT No.: PCT/AU2020/000110

§ 371 Date: Mar. 23, 2022

(30) Foreign Application Priority Data
Sep. 24, 2019 (AU) 2019903564

(51) Int. Cl. F16D 51/22; B25B 27/14; F16D 65/08; F16D 65/22; F16D 65/00

(52) U.S. Cl. CPC F16D 51/22; B25B 27/14; F16D 65/08; F16D 65/22; F16D 65/0043

(57) ABSTRACT

The present disclosure relates to heavy vehicle drum brakes. In a particular form, the present disclosure relates to a brake shoe configured for ease of changing thereof, and to an apparatus and method for changing drum brake shoes. In one aspect, the brake shoe comprises a lining table supporting a brake lining, and at least one web extending from the lining table, the web comprising a spring attachment aperture extending therethrough, the brake shoe further comprising an access aperture extending through the lining table and the brake lining, wherein a center line of the access aperture intersects, or is at least close to intersecting, a center line of the attachment aperture.

### CROSS-REFERENCE TO RELATED APPLICATIONS

The present application is a US national stage application of International Application Number PCT/AU2020/000110 filed 23 Sep. 2020, which claims priority from Australian Provisional Patent Application No. 2019903564 titled “A DRUM BRAKE SHOE AND AN APPARATUS AND METHOD FOR CHANGING SAME” and filed on 24 Sep. 2019, the content of each application of which is hereby incorporated by reference in its entirety.

### INCORPORATION BY REFERENCE

The following publication is referred to in the present application and its contents are hereby incorporated by reference in their entirety:

International Patent Application No. PCT/AU2017/000239 (WO2018/094441) titled “HEAVY VEHICLE DRUM BRAKE IMPROVEMENTS” in the name of Ken Pitt.

### BACKGROUND

### Technical Field

The present disclosure relates to heavy vehicle drum brakes. The term ‘heavy vehicles’ generally envisages trucks and trailers therefor. In a particular form the present disclosure relates to a brake shoe, and to an apparatus and method for changing drum brake shoes.

### Description of the Related Art

Compressed air brake systems are generally used on heavy vehicles such as trucks, and particularly those having one or more trailers which must be linked into the brake system. Reasons for this include the fact that the air brake circuits on trailers can be easily and safely attached, and the supply of air is unlimited, so that systems can never run out of their operating fluid.

Drum brakes are commonly employed on trucks and trailers, because they are considered to be more durable than disc brakes, requiring fewer lining replacements in a given period. What is more, replacement parts for drums are typically cheaper due to a larger economy of scale.

Drum brakes in compressed air brake systems are generally of a cam follower type. That is to say, at least one end of each brake shoe comprises a cam follower (a roller) which follows a generally ‘S’ shaped cam, which depends from a shaft rotationally driven via an air-powered brake booster, which is located outside of the wheel.

One or more return springs bridge (i.e., extend between) a pair of brake shoes inside of a drum of a typical drum brake assembly, and perform the dual functions of returning the brake shoes to their resting condition when the brake pedal is released, and maintaining the cam followers in contact with the S-cam.

When the brake shoes and/or return springs are changed and/or the drum brake assembly is serviced, the or each spring must be removed in order to release the brake shoes, and then be refitted during reassembly. Disassembly involves overcoming the bias of the spring so that each end of the spring may be unhooked from a bolt extending between the webs of one of the brake shoes, and reassembly involves reversing this process, by hooking the spring ends on the bolts. These tasks are made difficult by both the strength of the spring, and the limited access provided to the ends of the spring, which are nested between the two webs of each of the two brake shoes. Consequently, removal of the wheel hub is required to facilitate adequate access to perform these tasks, but disassembly and reassembly of the hub are both time consuming, and thus costly, and may void the warranty of parts such as wheel bearings.

It is against this background and the problems and difficulties associated therewith that the present disclosure has been developed.

Certain objects and advantages of the present disclosure will become apparent from the following description, taken in connection with the accompanying drawings, wherein, by way of illustration and example, an embodiment of the present invention is disclosed.

### BRIEF SUMMARY

According to a first aspect, there is provided a drum brake shoe adapted to provide access to an end of a return spring engaged with respect thereto.

According to a further aspect, there is provided a tool for use with the above described drum brake shoe to disengage the return spring therefrom.

According to yet a further aspect, there is provided a method for using the above described tool to disengage the return spring from the brake shoe.

According to a further aspect, there is provided a method for using the above described tool to engage the return spring with respect to the brake shoe.

In one form, the brake shoe comprises a lining table supporting a brake lining, and at least one web extending from and along an underside of the lining table, the web comprising a return spring attachment aperture extending therethrough, the brake shoe further comprising an access aperture extending through the lining table and the brake lining, wherein a center line of the access aperture intersects, or is at least close to intersecting, a center line of the return spring attachment aperture.

In one form, the brake shoe comprises a lining table supporting a brake lining, and at least one web extending from and along an underside of the lining table, the web comprising a return spring attachment aperture extending therethrough, the brake shoe further comprising an access aperture extending through the lining table and the brake lining, wherein the access aperture extends in a direction toward to the return spring attachment aperture.

In one form, the access aperture is circular.

In one form, the access aperture is slotted. In one form, the slot extends transversely across the shoe. In one form, the slot extends lengthwise along the shoe. Slotting the access aperture will provide an increased range of movement for the tool in the direction of elongation.

In one form, the access aperture in non-tapered. In one form, the access aperture is tapered. Tapering the access aperture will provide a larger opening at one end of the aperture.

In one form, in an alternative, more than one access aperture is provided. One access aperture should suffice however.

In one form, in use, the return spring attachment aperture receives a pin or bolt with which the return spring is engaged.

In one form, the brake shoe comprises a pair of webs.

In one form, the webs are substantially parallel.

In one form, the access aperture is located between the webs.

In one form, both of the webs comprise a return spring attachment aperture.

In one form, the return spring attachment aperture in each of the webs is longitudinally coaxial. This allows the pin or bolt to pass through the return spring apertures and extend between the webs.

In one form, the access aperture extends substantially normal to the or each return spring attachment aperture.

In one form, both of the webs comprise a mount for a follower for an actuating cam.

In one form, the actuating cam is an S-cam.

In one form, the brake shoe comprises a brake shoe guide extending from at least one web thereof.

In one form, this brake shoe guide is of the type disclosed in WO2018/094441.

In one form, said one web is the outboard web in use.

In one form, the brake shoe is a heavy vehicle brake shoe.

According to a further aspect, there is provided a brake shoe comprising a lining table supporting a brake lining, and a pair of webs extending in parallel from and along an underside of the lining table, each of the webs comprising a return spring attachment aperture extending therethrough so that the two return spring attachment apertures are coaxial, the brake shoe further comprising an access aperture extending through the lining table and the brake lining, wherein a center line of the access aperture intersects a center line of the return two attachment apertures.

According to a further aspect, there is provided a brake shoe assembly comprising a brake shoe and a return spring attachment pin or bolt, the brake shoe comprising a lining table supporting a brake lining, and at least one web extending from and along an underside of the lining table, the web comprising a return spring attachment aperture extending therethrough in which the pin or bolt is received, the brake shoe further comprising an access aperture extending through the lining table and the brake lining, wherein the access aperture is directed at the pin or bolt.

According to a further aspect, there is provided a brake shoe assembly comprising a brake shoe and a return spring attachment pin or bolt, the brake shoe comprising a lining table supporting a brake lining, and a pair of webs extending in parallel from and along an underside of the lining table, each of the webs comprising a return spring attachment aperture extending therethrough in which the pin or bolt is received, the brake shoe further comprising an access aperture extending through the lining table and the brake lining, wherein the access aperture is directed at the pin or bolt.

In one form, the tool comprises a lever element, and a tether element depending from the lever element.

In one form, the tether element comprises a loop.

In one form, the tether element is formed from a cable, zip tie or light chain.

In one form, the method comprises the steps of passing the tether element through the access aperture in the brake shoe and engaging an end of the return spring with the tether element, and then using the lever element as a lever to stretch the return spring to engage or disengage this (as required) with respect to the brake shoe.

In one form, in an alternative, the tool comprises a lever element, and a hook element comprising a stem portion and a hooked portion extending from the stem, where the stem of the hook element is pivotally connected to the lever element at or near an end thereof which is distal to the hooked portion.

In one form, the hook element is pivotally connected to the lever element at a point which is closer to one end of the lever element than the other. In this way a mechanical advantage can be achieved for a user.

In one form, the method comprises the steps of passing the hook element through the access aperture in the brake shoe and engaging an end of the return spring with the hooked portion, and then using the lever element as a lever to stretch the return spring to engage or disengage this (as required) with respect to the brake shoe.

In one form, the aperture is sized and shaped to permit use of the tool, but the aperture should not be larger than is strictly necessary for access, as this would unnecessarily reduce the amount of lining material on the brake shoe.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE SEVERAL VIEWS OF THE DRAWINGS

Embodiments of the present disclosure will be discussed with reference to the accompanying drawings wherein:

FIG. 1 is an isometric view of a brake shoe;

FIG. 2 is a side view of the brake shoe of FIG. 1;

FIG. 3 is an upper view of the brake shoe of FIG. 1;

FIG. 4 is a lower view of the brake shoe of FIG. 1;

FIG. 5 is a side view of an arrangement including a portion of a drum brake assembly including an S-cam, a return spring and a pair of the brake shoes as illustrated in FIG. 1, and further illustrating a tool for engaging the return spring;

FIG. 6 is a top view of the arrangement illustrated in FIG. 5;

FIG. 7 is an end view of the arrangement illustrated in FIG. 5; and

FIG. 8 is a cross-sectional view taken along A-A of FIG. 6.

In the following description, like reference characters designate like or corresponding parts throughout the figures.

### DETAILED DESCRIPTION

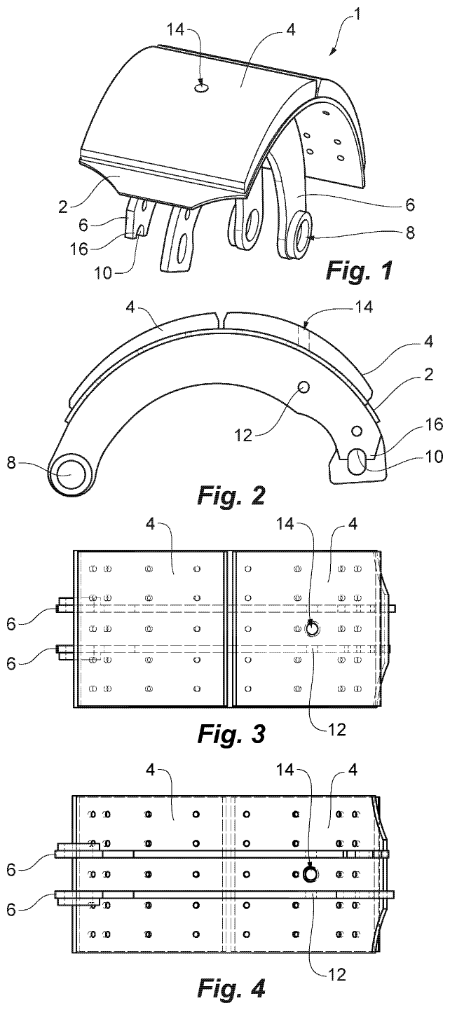

Referring now to FIG. 1, where there is illustrated a brake shoe 1 comprising a lining table 2 having a working face and a backing face, where a brake lining 4 depends from the working face, and a pair of parallel, spaced apart webs 6 depend from the backing face so as to extend from and along this.

Each web 6 of the brake shoe 1 comprises one of a pair of mutually aligned anchor pin holes 8, via which that brake shoe 1 may be pivotally attached to a stationary carrier associated with the axle assembly. Each web 6 further comprises, at an end distal to the anchor pin holes 8, one of a pair of mutually aligned generally U-shaped cam follower mounts 10, for mounting opposite ends of a cam follower in the form of a roller retained therein by retaining clips (not illustrated).

Each web 6 of the brake shoe 1 comprises a return spring attachment aperture 12 extending therethrough, and these are longitudinally coaxial. In use, these return spring attachment apertures 12 receive a pin or bolt 150 therethrough so that this pin or bolt 150 bridges the webs 6.

The brake shoe 1 further comprises an access aperture 14 extending through the lining table 2 and the brake lining 4. In the illustrated embodiment, this access aperture 14 comprises a circular hole, but other aperture shapes may be employed as necessary to permit access. A center line of the access aperture 14 intersects a center line of the return spring attachment apertures 12. That is to say, the access aperture 14 extends in a direction toward the attachment aperture 12.

In the case of the illustrated embodiment, the brake shoe 1 further comprises a brake shoe guide 16 extending from what will, in use, be an outboard web thereof. This brake shoe guide 16 is of the type disclosed in WO2018/094441. It extends lengthwise from this outboard web so as to make it longer than the other web, so that the guide 16 extends in front of, and in sliding contact with, an outboard face of an actuating cam 100. In use, the guide 16 prevents brake shoe misalignment in brake drums of heavy vehicles.

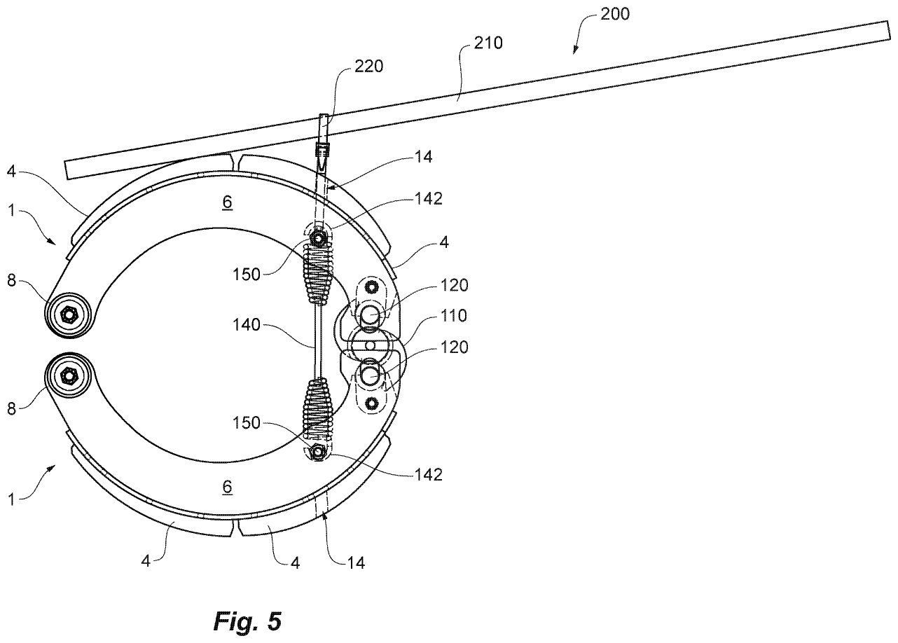

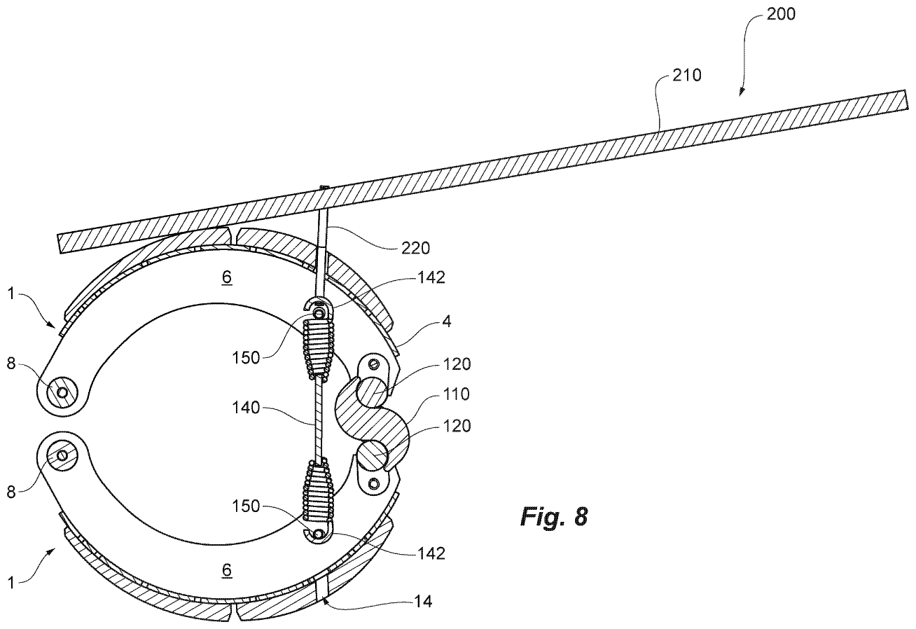

Referring now to FIGS. 5 through 8, there is shown a portion of a typical drum brake assembly from a compressed air brake system of a heavy vehicle such as a semi-trailer prime mover or trailer.

The drum brake assembly comprises the aforementioned stationary carrier (not illustrated) upon which a pair of the arcuate brake shoes 1 are pivotally mounted in an oppositely directed arrangement, for enclosure within and cooperation with a cylindrical internal surface of a rotatably mounted brake drum (not illustrated), with respect to which a wheel assembly of the vehicle is attached.

The drum brake assembly will further comprise a shaft extending from an air-powered brake booster (not illustrated, but typically depending from an axle housing for the wheels) into the brake drum, where it terminates at an S-shaped actuating cam (hereinafter S-cam) 110 which interposes the cam followers 120.

A return spring 140 bridges (i.e., extends between) and is secured with respect to each of the pair of brake shoes 1 inside of the drum, and performs the dual functions of returning the brake shoes 1 to their resting condition when the brake pedal is released, and maintaining the cam followers 120 in contact with the S-cam 110. A typical return spring 140 comprises a hook 142 at each end thereof, which is hooked around one of the bolts 150 extending through the return spring attachment apertures 12 and thus between the webs 6 of each of the pair of brake shoes 1.

In use, when the brake pedal of the vehicle is pushed, compressed air is supplied to the air-powered brake booster, which rotates the S-cam 110 via a push rod, a slack adjuster (i.e., a lever—not shown) and then the shaft, driving the brake shoes 1 outward into contact with the drum brake.

As discussed in the background, when the brake shoes 1 are changed and/or the drum brake assembly is serviced, the return spring 140 must be removed in order to release the brake shoes 1. This involves overcoming the bias of the spring 140 so that the hook 142 at each end of the spring 140 may be unhooked from a bolt 150 extending between the webs 6 of one of the brake shoes 1.

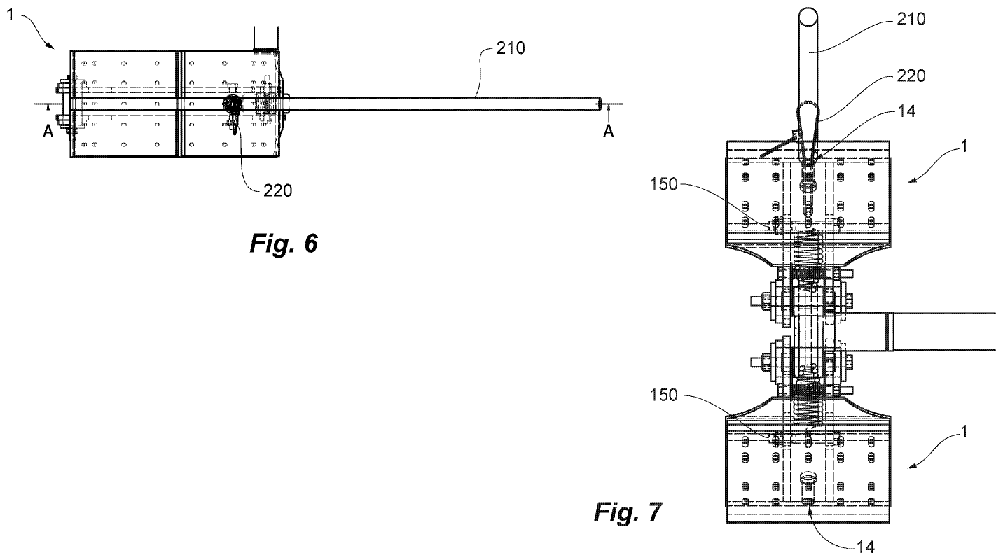

Referring now to FIGS. 5 and 6, a tool 200 for use with the brake shoe 1 is illustrated.

The tool 200 comprises a lever element 210, and a tether element 220 depending from the lever element 210. In the illustrated embodiment, the tether element 220 comprises a cable or zip tie formed into a loop which is passed around the lever element 210 and secured in position with respect to the lever element 210.

In use, the tether element 220 is passed through the access aperture 14 in the brake shoe 1 so as to engage (by looping around the hook 142) an end of the return spring 140. The lever element 210 can then be used as a lever to stretch the return spring 140 to disengage this from the bolt 150 and thus with respect to the brake shoe 1.

When the drum brake assembly is reassembled, the tether element 220 is passed through the access aperture 14 in the brake shoe 1 so as to engage (by looping around the hook 142) an end of the return spring 140. The lever element 210 can then be used as a lever to stretch the return spring 140 to engage this with the bolt 150 and thus with respect to the brake shoe 1.

Advantageously, the brake shoe 1 can be used as a substitute for a conventional brake shoe without need for modification or replacement of existing brake hardware.

Moreover, the brake shoe disclosed herein permits external access to an end of a return spring engaged with respect thereto, or to be engaged with respect thereto. As a result, disengagement, removal, and fitment of the return springs is made significantly easier and quicker, and can be achieved without removal of the wheel hub or disruption of the wheel bearings. This represents a significant saving in servicing time and equipment downtime, and therefore money.

Moreover, additional advantage is realized in the case of smaller drum brake assemblies, such as those employed on low loader trailers, where access for maintenance is reduced even further.

Further advantage still is realized in that the present invention makes for ease of maintenance of brakes employing stronger return springs, which themselves are advantageous in as much as they improve brake operation, and reduce wear of components, such as flat spotting of rollers.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

In general, in the following claims, the terms used should not be construed to limit the claims to the specific embodiments disclosed in the specification and the claims, but should be construed to include all possible embodiments along with the full scope of equivalents to which such claims are entitled.

1. A brake shoe comprising a lining table supporting a brake lining, and at least one web extending from and along an underside of the lining table, the web comprising a return spring attachment aperture extending therethrough, the brake shoe further comprising an access aperture extending through the lining table and the brake lining, wherein a center line of the access aperture intersects, or is at least close to intersecting, a center line of the return spring attachment aperture.

2. The brake shoe of claim 1, wherein in use, the return spring attachment aperture receives a pin or bolt with which the spring is engaged.

3. The brake shoe of claim 1, wherein the brake shoe comprises a pair of webs.

4. The brake shoe of claim 3, wherein the webs are substantially parallel.

5. The brake shoe of claim 3, wherein the access aperture is located between the webs.

6. The brake shoe as of claim 3, wherein both of the webs comprise a return spring attachment aperture.

7. The brake shoe of claim 6, wherein the return spring attachment aperture in each of the webs is longitudinally coaxial with each other.

8. The brake shoe of claim 7, wherein a center line of the access aperture intersects a center line of the two return spring attachment apertures.

9. The brake shoe of claim 1, wherein the access aperture extends substantially normal to the return spring attachment aperture.

10. The brake shoe of claim 3, wherein both of the webs comprise a mount for a follower for an actuating cam.

11. The brake shoe of claim 1, wherein the brake shoe comprises a brake shoe guide extending from the at least one web thereof.

12. The brake shoe of claim 11, wherein the web with the brake shoe guide is an outboard web in use.

13. The brake shoe of claim 1, wherein the brake shoe is a heavy vehicle brake shoe.

14. A brake shoe comprising a lining table supporting a brake lining, and a pair of webs extending in parallel from and along an underside of the lining table, each of the webs comprising a return spring attachment aperture extending therethrough so that the return two spring attachment apertures are coaxial, the brake shoe further comprising an access aperture extending through the lining table and the brake lining, wherein a center line of the access aperture intersects a center line of the two return spring attachment apertures.

15. A brake shoe assembly comprising a brake shoe and a return spring attachment pin or bolt, the brake shoe comprising a lining table supporting a brake lining, and at least one web extending from and along an underside of the lining table, the web comprising a return spring attachment aperture extending therethrough in which the pin or bolt is received, the brake shoe further comprising an access aperture extending through the lining table and the brake lining, wherein the access aperture is directed at the pin or bolt.

16. A brake shoe assembly comprising a brake shoe and a return spring attachment pin or bolt, the brake shoe comprising a lining table supporting a brake lining, and a pair of webs extending in parallel from and along an underside of the lining table, each of the webs comprising a return spring attachment aperture extending therethrough in which the pin or bolt is received, the brake shoe further comprising an access aperture extending through the lining table and the brake lining, wherein the access aperture is directed at the pin or bolt.

17-25. (canceled)
